(19) United States
(12) Patent Application Publication
(10) Pub. No.: US 2014/0106112 A1
(43) Pub. Date: Apr. 17, 2014

(54) METAL FOIL WITH CARRIER

(71) Applicant: Freesia Macross Corporation, Tokyo (JP)

(72) Inventor: Beji SASAKI, Tokyo (JP)

(73) Assignee: Freesia Macross Corporation, Tokyo (JP)

(21) Appl. No.: 14/144,674

(22) Filed: Dec. 31, 2013

Related U.S. Application Data
(62) Division of application No. 13/984,591, filed on Aug. 9, 2013.

(30) Foreign Application Priority Data
Feb. 10, 2011 (JP) 2011-027455

(51) Int. Cl. B32B 15/082

(52) U.S. Cl. CPC B32B 15/082
USPC 428/78

(57) ABSTRACT

A metal foil with a carrier includes a non-metallic plate-shaped carrier, a metal foil laminated on at least one surface of the carrier, and a low-adhesion material provided between the metal foil and the carrier to adhere to the metal foil. A cutout region where the metal foil is surrounded by the carrier is provided around the metal foil.

### TECHNICAL FIELD

The present invention relates to a metal foil with a carrier used in production of a laminated substrate (a coreless substrate, an all-layer build-up substrate), and a method for producing a laminated substrate using the same.

### BACKGROUND ART

Precedent I

Demands for lighter, thinner, and smaller electronic devices and the like are endless in recent years. Accordingly, demands for improvements in basic components of the electronic devices and the like are growing, such as multilayer structures of printed wiring boards, higher densification of metal foil circuits, and thinner substrates by reducing the thickness to the utmost limit.

In general, a multilayer structure of a conventional substrate is formed by repeating a process (a build-up process) to laminate a prepreg (prepared by impregnating a glass woven cloth with epoxy resin and semi-curing the resin) and a copper foil on a copper-attached laminated plate called a CCL (copper clad laminate) and then to form a circuit and the like (see Patent Literature 1, for example).

However, the reduction in thickness of such a laminated substrate leads to a demand for a reduction in thickness of the CCL. In recent years, an ultrathin CCL having a thickness of about 20 pm is being developed and adopted in amass production process of ultrathin substrates.

The CCL has a function as a baseplate (a support for retaining flatness) during formation of a laminated substrate. Nevertheless, the CCL is losing its function as the support for retaining flatness as the CCL becomes thinner, and there are various problems arising therefrom in the mass production process.

Precedent II

There is an attempt to use a metal plate such as an SUS (stainless used steel) intermediate plate as a baseplate. Specifically, there is a coreless substrate obtained by: attaching copper foils onto the metal plate by using a low-adhesion material; and forming build-up layers thereon.

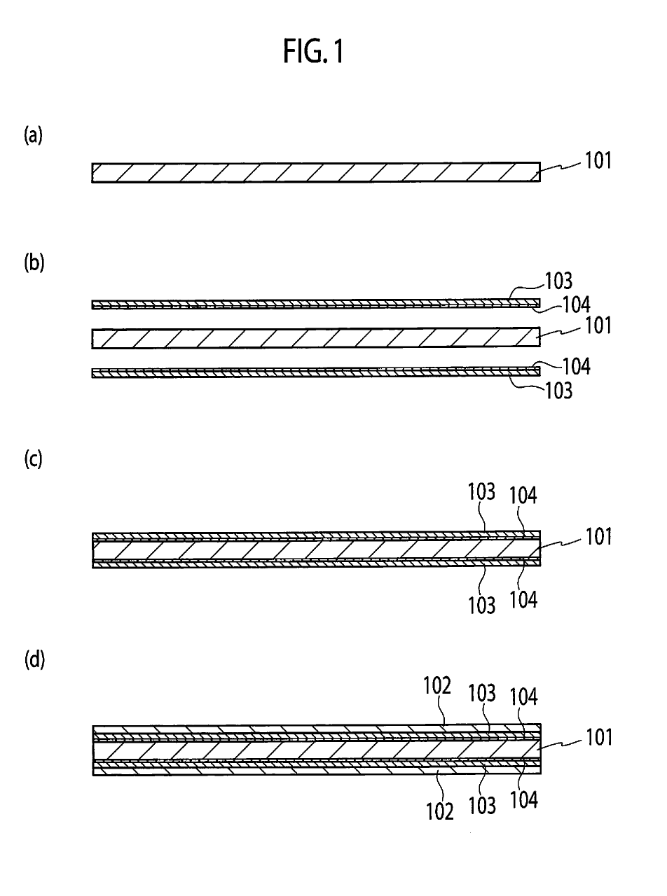

As shown in FIGS. 1(a) to 1(d), 2(a) to 2(c), and 3(a) to 3(d), copper foils 103 are first laminated on both surfaces of a metal (SUS) base material 101 by using low-adhesion materials 104. Next, prepregs and copper foils 102 are laminated and then subjected to outline machining, whereby via-holes and circuits are formed thereon (a build-up process). A coreless substrate having an all-layer build-up structure is produced by repeating the above-mentioned processes (although illustration is omitted therein, the outline machining is performed on each laminated layer). In this process, an SUS intermediate plate is used as a carrier of the coreless substrate. Since the coreless substrate is formed on each side of the carrier, there is an advantage that the two substrates can be processed in one plating process, for example, and productivity of the substrates are therefore high.

### CITATION LIST

### Patent Literature

### [PTL 1] Japanese Unexamined Patent Application Publication No. 2009-272589

### SUMMARY OF INVENTION

However, if the ultrathin CCL is used as described in Precedent I above, the CCL cannot be passed through an ordinary etching line because the CCL is a material which is as thin as a sheet of paper.

In particular, when the coreless substrate is conveyed with rollers, the CCL is apt to cause crinkles and folds during lamination work because the CCL bends and falls in a gap between the rollers due to its own weight. Hence, a problem of deterioration in yield arises as a consequence.

In the meantime, the ultrathin CCL includes internal strain. Specifically, the prepregs transit to a C stage (final-stage curing) due to polymerization at the time of production of the CCL, and are hence cured and stabilized. However, the CCL undergoes cure shrinkage at this time.

The CCL includes the shrinkage strain. As a consequence, although no warpage or shrinkage occurs owing to a symmetric effect of the CCL in a three-layered structure (a situation where the copper foils support from both sides), such warpage or shrinkage may occur at a portion removed by etching, whereby alignment upon patterning (pattern position alignment) in a subsequent process and scaling work (setting a magnification with respect to a mask film) become infeasible.

For example, the ultrathin CCL after entirely removing one side by etching releases the shrinkage strain attributed to the prepreg and is deformed into a roll, which complicates processing in a subsequent process.

Further, as in the case of Precedent II, in the method using the metal plate, a metal component may elute off in an etching or plating process at the time of circuit formation, thereby causing a problem of contamination of an etching or plating solution.

Moreover, in the method using the metal plate, the low-adhesion layer (the low-adhesion material 104) is provided between the base material 101 and the copper foil 103, because the base material 101 needs to be detached easily after the production of a coreless substrate 100.

In the method using the metal plate, an end portion of the metal plate is exposed in the outline machining process and an interface between the metal plate and the copper foil 103 adopting a low-adhesion structure is easily detachable. Accordingly, when the metal plate is immersed in a chemical solution in the etching or plating process, the chemical solution infiltrates from the interface of the low-adhesion portion between the metal plate and the copper foil 103 and adversely affects a subsequent process.

On the other hand, at a time of disassembly in a final process, it is preferable that the interface between the copper foil 103 and the metal plate be easily detachable. In other words, there is a relation of a trade-off between the factor that the interface is desired to establish as tight adhesion as possible in the production process so as to avoid the infiltration of the chemical solution and the factor that the interface needs to be easily detachable at the time of disassembly.

In addition, the low-adhesion material 104 remains on a surface of the disassembled coreless substrate 100. In general, the low-adhesion material 104 is water-insoluble, and therefore needs to be removed by a physical polishing or chemical polishing process.

However, it is difficult to remove the low-adhesion material 104 evenly, and an adverse effect on a subsequent process is therefore unavoidable.

An object of the present invention is to provide a metal foil with a carrier capable of improving workability of producing a laminated substrate, and a method for producing a laminated substrate using the metal foil with a carrier.

A first aspect of the present invention is a metal foil with a carrier including a non-metallic plate-shaped carrier, a metal foil laminated on at least one surface of the carrier, and a low-adhesion material provided between the metal foil and the carrier to adhere to the metal foil and made of a mixture of polyvinyl alcohol and silicone.

According to the first aspect, the low-adhesion material is made of the mixture of polyvinyl alcohol and silicone. Thus, the low-adhesion material in excess can be easily removed by water rinsing or acid rinsing during work for producing a laminated substrate.

In addition, since the low-adhesion material can be easily removed by water rinsing or acid rinsing, the low-adhesion material can be evenly removed. Thus, it is possible to provide the metal foil with a carrier which can improve workability of producing a laminated substrate.

A cutout region where the metal foil is surrounded by the carrier may be provided around the metal foil.

According to the above-described configuration, the cutout region where the metal foil is surrounded by the carrier is provided around the metal foil. Thus, the low-adhesion material is prevented from being exposed from an end surface of the metal foil to outside, and from detachment caused by a machining load associated with the exposure of the low-adhesion material to the outside.

A second aspect of the present invention is a method of manufacturing a laminated substrate using a metal foil with a carrier provided with a non-metallic plate-shaped carrier, a metal foil laminated on at least one surface of the carrier, and a low-adhesion material provided between the metal foil and the carrier to adhere to the metal foil, the method including laminating a thin film of the metal foil and the low-adhesion material adhering to the metal foil, on the carrier, cutting a cutout region provided around the metal foil and where the metal foil is surrounded by the carrier, and detaching the thin film laminated on the carrier from the carrier.

According to the second aspect, the production method does not use an SUS intermediate plate (a metal) and the like. Thus, there is no contamination of an etching solution which is attributed to elution of a component of the SUS intermediate plate (the metal) and the like.

As a consequence, by applying the above-described processes, it is possible to provide the method for producing a laminated substrate using the metal foil with a carrier, which can improve workability of producing a laminated substrate.

### BRIEF DESCRIPTION OF DRAWINGS

### [FIG. 1]

FIGS. 1(a) to 1(d) are views showing a conventional method of producing a coreless substrate.

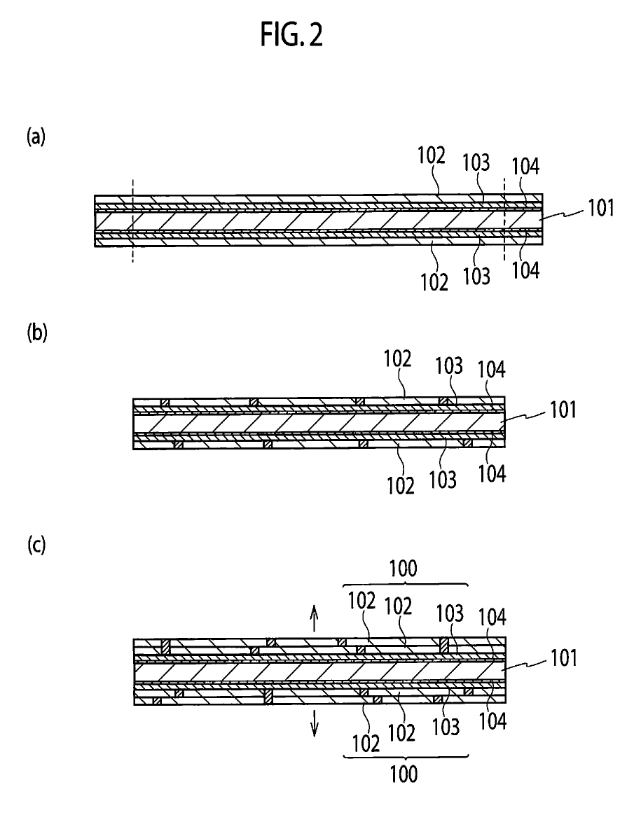

### [FIG. 2]

FIGS. 2(a) to 2(c) are views showing the conventional method of producing a coreless substrate.

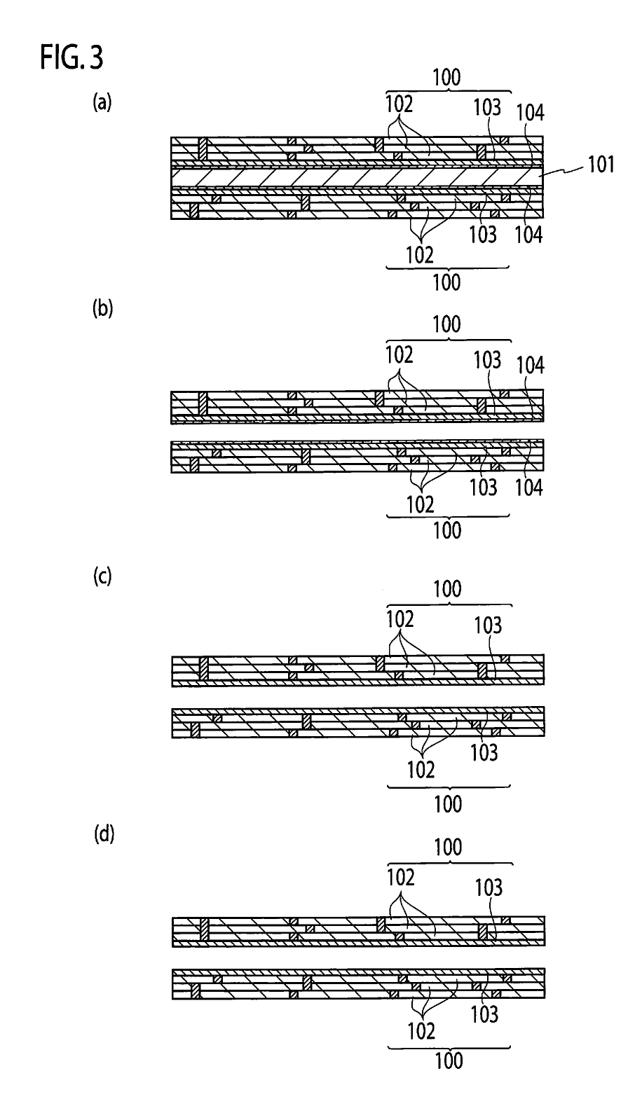

### [FIG. 3]

FIGS. 3(a) to 3(d) are views showing the conventional method of producing a coreless substrate.

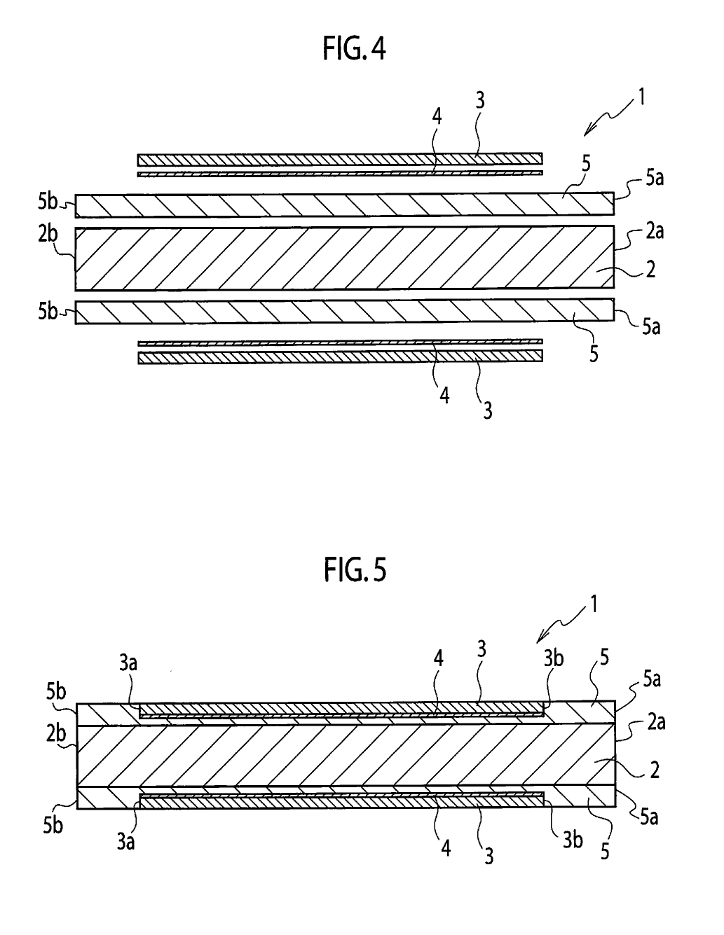

### [FIG. 4]

FIG. 4 is a view showing a configuration of a metal foil with a carrier according to an embodiment of the present invention.

### [FIG. 5]

FIG. 5 is a view showing the metal foil with a carrier according to the embodiment of the present invention after being subjected to press forming.

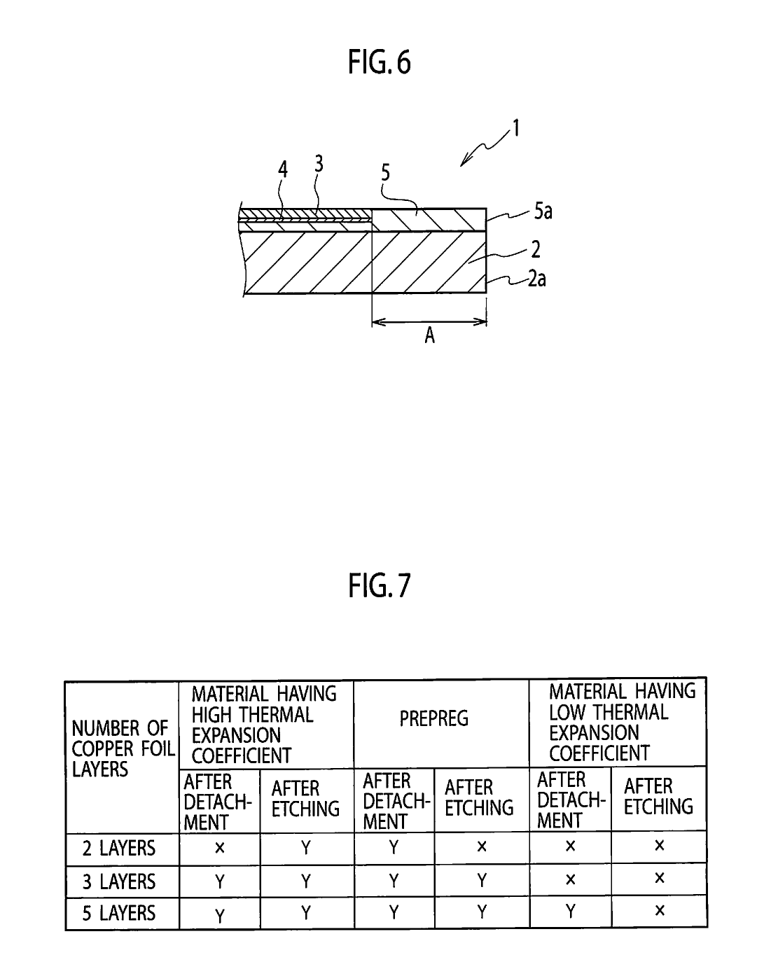

### [FIG. 6]

FIG. 6 is a partially enlarged view of the metal foil with a carrier according to the embodiment of the present invention.

### [FIG. 7]

FIG. 7 is a reference table for explaining materials to be used as a carrier according to the embodiment of the present invention.

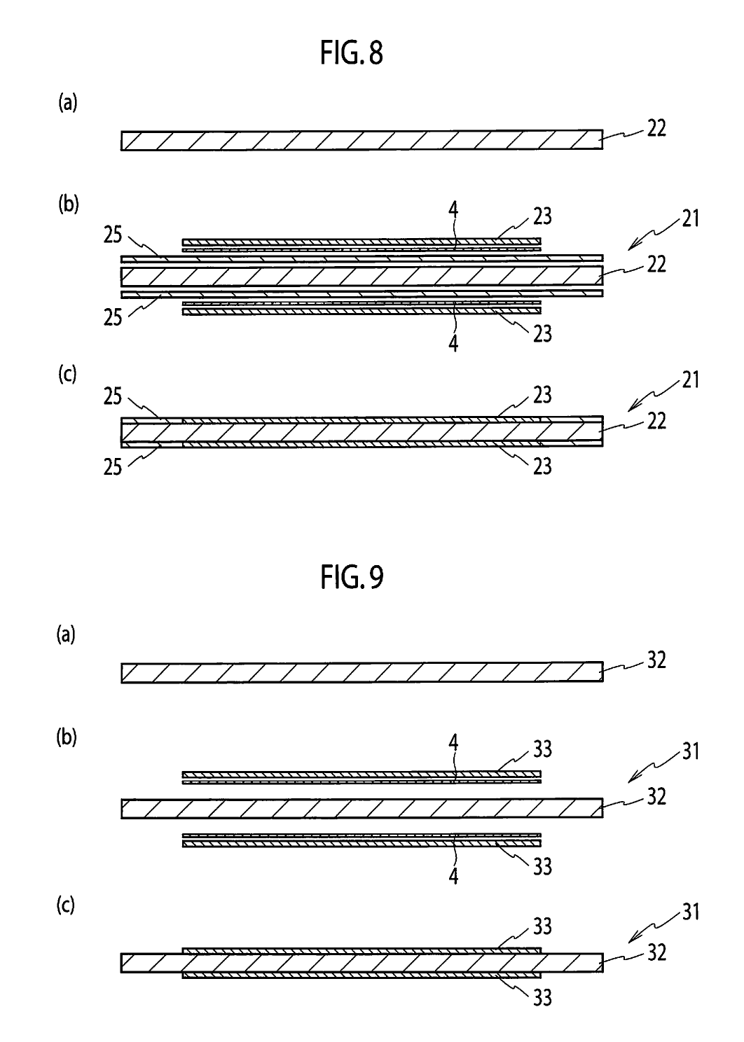

### [FIG. 8]

FIGS. 8(a) to 8(c) are views showing a configuration of a metal foil with a carrier according to Example 1 of the present invention.

### [FIG. 9]

FIGS. 9(a) to 9(c) are views showing a configuration of a metal foil with a carrier according to Example 2 of the present invention.

### DESCRIPTION OF EMBODIMENTS

An embodiment of the present invention will be described below with reference to the drawings. The present invention relates to a metal foil with a carrier used in production of a laminated substrate (a coreless substrate, an all-layer build-up substrate), and a method for producing a laminated substrate using the metal foil with a carrier.

To begin with, a metal foil with a carrier according to an embodiment of the present invention will be described with reference to FIG. 4 to FIG. 7.

FIG. 7 is a reference table for explaining materials to be used as a carrier according to the embodiment of the present invention, which is a table showing relations between thermal expansion coefficients and amounts of warpage after detachment in the materials used as the carrier. The letter “X” in FIG. 7 denotes the warpage equal to or above 1 mm relative to a length of 100 mm and the letter “Y” therein denotes the warpage equal or below 1 mm relative to the length of 100 mm.

As shown in FIG. 4 to FIG. 6, a metal foil 1 with a carrier essentially includes: a non-metallic plate-shaped carrier (a base material) 2; a copper foil (a metal foil) 3 laminated on at least one surface of the carrier 2; and a low-adhesion material 4 provided between the copper foil 3 and the carrier 2 and adhering to the copper foil 3.

A material having rigidity sufficient to prevent the occurrence of crinkles, warpage, a change in scaling (shrinkage of the carrier), and the like during processes for producing a laminate substrate (a lamination process, in particular) is applied to the material used as the carrier (the base material) 2.

As shown in FIG. 7, for the selection of the material to be applied to the carrier (the base material) 2, after repeating lamination of the copper foils and prepregs on the one surface and the other surface of the material, reference is made to the warpage (indicated as after detachment in FIG. 7) after detaching a laminate (the laminated substrate) from the base material, and to the warpage (indicated as after etching therein) of the laminate after removing the copper foil on one side by etching.

As for the warpage of the laminates (the laminated substrate), reference is made to the warpage in two-, three- and five-layered laminates (indicated as the number of copper layers in FIG. 7) in which two layers, three layers and five layers are laminated on the base material, where one layer includes a copper foil (an electrolytic copper foil having a thickness of 5 μm) and a prepreg (a FR-4 multilayer material having a thickness of 20 μm) to be laminated on one surface of the material.

The metal foil 1 with a carrier according to the embodiment of the present invention can be made in a multilayer structure having more than 5 layers by laminating the prepregs and the copper foils 3 likewise.

As for other materials, reference is made to: an indium plate (32.1×10⁻⁶/k) having a thickness of 1 mm as a material having a high thermal expansion coefficient; a prepreg (C stage, 17.0×10⁻⁶/k) having a thickness of 1 mm as a material having a thermal expansion coefficient of a constituent material of the substrate; and a glass plate (2.8×10⁻⁶/k) having a thickness of 1 mm as a material having a low thermal expansion coefficient.

As shown in FIG. 7, when the prepreg is used as the base material (the carrier), no warpage occurs after the laminate (the laminated substrate) is detached from the base material. However, the warpage occurs after etching the copper foil when the number of the copper foil layers is equal to two layers.

This is due to the fact that an internal stress attributed to cure shrinkage of the prepreg is released as a result of detachment. In the case of the laminate having the number of copper foil layers equal to or above three layers, no warpage occurs after detachment or etching because the rigidity of the laminate (the laminated substrate) is increased.

In the meantime, when the high thermal expansion coefficient material is used as the base material, the warpage occurs after detachment due to a difference in the thermal expansion coefficient. Nevertheless, no warpage occurs after etching the copper layer. This is due to the fact that the high thermal expansion coefficient material relaxes (cancels) the internal stress attributed to the cure shrinkage of the prepreg.

On the other hand, when the low thermal expansion coefficient material is used as the base material, the warpage occurs after detachment due to a difference in the thermal expansion coefficient. Moreover, even larger warpage occurs after etching the copper foil. This is due to the fact that the internal stress attributed to the cure shrinkage of the prepreg is released as a result of detachment and etching.

Accordingly, in light of the thermal expansion coefficient of the material used as the carrier (the base material) 2 of the embodiment of the present invention, it is preferable to apply a material having the thermal expansion coefficient equal to or greater than that of the prepreg (such as the indium plate having the thickness of 1 mm).

When the material having the thermal expansion coefficient equal to or greater than that of the prepreg (such as the indium plate having the thickness of 1 mm) is used as the carrier (the base material) 2, no warpage occurs after detachment or etching as long as the laminate (the laminated plate) has the number of copper foil layers equal to or above three layers.

Since the expansion coefficient of the carrier (the base material) 2 is optimized as described above, occurrence of the warpage, the change in scaling and the like can be eliminated and a product yield can be improved.

The copper foil (the metal foil) 3 is an electrolytic copper foil made of copper, a copper alloy or the like, which is laminated on one surface and the other surface of the carrier 2. Instead of the copper foil 3, it is possible to use foils of aluminum, nickel, zinc, and the like.

The low-adhesion material 4 adheres to the copper foil 3. A bonding agent 5 (see FIG. 6) is provided between the carrier 2 and the copper foil 3 to which the low-adhesion material 4 adheres (is applied). The carrier 2 and the copper foil 3, to which the low-adhesion material 4 adheres, are bonded together by the bonding agent 5.

The low-adhesion material 4 is made of a mixture of polyvinyl alcohol (hereinafter referred to as PVA) and silicone. Specifically, the low-adhesion material 4 is prepared by mixing a silicone resin with an aqueous solution of polyvinyl alcohol (PVA).

Tack strength of the low-adhesion material 4 thus prepared is variable by changing the mixing ratio of PVA and the silicone resin. An increase in the proportion of PVA increases water solubility of the low-adhesion material 4.

For this reason, the low-adhesion material 4 according to the embodiment of the present invention preferably has the proportion of the mixed silicone resin in a range from 10% to 60% so as to obtain favorable solubility and favorable adhesion.

Here, the favorable adhesion corresponds to a value of detachment strength between the low-adhesion material 4 and the bonding agent 5 in a range from 5 g/cm to 500 g/cm. The favorable solubility corresponds to a situation where the low-adhesion layer having a thickness of 10 μm dissolves within 30 seconds when dipped in pure water at 20° C.

After disassembly of the laminated substrate, the low-adhesion material 4 remains on the surface of the substrate. Here, the low-adhesion material 4 is water-soluble and can therefore be easily removed by water rinsing or acid rinsing before formation of a circuit on the substrate. In addition, it is also possible to remove the low-adhesion material 4 evenly.

Next, a method for producing the metal foil with a carrier according to the embodiment of the present invention will be described. In the method for producing the metal foil with a carrier according to the embodiment of the present invention, the same bonding agent 5 simultaneously achieves bonding of end surfaces of the copper foil 3 adhering to the low-adhesion material 4 as well as bonding between the copper foil 3 adhering to the low-adhesion material 4 and the carrier (the base material) 2.

First, as shown in FIG. 4, the low-adhesion material 4 is applied to one surface (an S surface or a shiny surface) of each copper foil 3 (an application process) . Then, a thin film of the copper foil 3 to which the low-adhesion material 4 adheres (is applied) is cut into a predetermined size (a machining process).

Next, as shown in FIG. 5, the bonding agent 5 is placed between the carrier (the base material) 2 and the thin film of the copper foil 3 to which the low-adhesion material 4 is applied, and then these components are subjected to press molding (a press molding process). Here, the bonding agent 5 is brought into contact with the end surfaces of the copper foil 3 (one end 3a of the copper foil and another end 3b of the copper foil) by press molding.

Specifically, a sufficient amount of the bonding agent 5 is provided in order to bond the end surfaces of the copper foil 3 (the one end 3a of the copper foil and the other end 3b of the copper foil).

Since the bonding agent 5 bonds the end surfaces of the copper foil 3 (the one end 3a of the copper foil and the other end 3b of the copper foil) as described above, the bonding agent 5 can prevent a chemical solution in an etching or plating process from infiltrating between the copper foil 3 and the carrier base material 2. Thus, it is possible to avoid detachment of the copper foil 3 from the base material 2.

Next, outline machining is performed and then via-hole formation and circuit formation are conducted (a lamination process). Further, a build-up layer is formed by repeating lamination, via-hole formation, and circuit formation.

Next, in outline machining after lamination (such as a reference surface grinding process), a portion A (a cutout region) are cut out from the end surfaces of the copper foil 3 (the one end 3a of the copper foil and the other end 3b of the copper foil) to end surfaces of the carrier (the base material) 2 (one end side 2a of the base material and another end side 2b of the base material), and to end surfaces of the bonding agent 5 (one end side 5a of the bonding agent and another end side 5b of the bonding agent), respectively, as shown in FIG. 5 and FIG. 6 (note that only the one end side is shown in FIG. 6).

In this way, the low-adhesion material 4 is not exposed from the end surfaces of the copper foil 3 (the one end 3a of the copper foil and the other end 3b of the copper foil) to outside. Accordingly, an interface between the carrier 2 and the copper foil 3 adopting a low-adhesion structure is not detached.

In addition, during immersion in the chemical solution in the etching or plating process, the chemical solution does not infiltrate from the interface at the low-adhesion portion between the carrier 2 and the copper foil 3 or does not adversely affect a subsequent process. Thus, it is possible to avoid detachment of the low-adhesion material 4 which would otherwise occur due to a machining load, which is associated with the exposure of the low-adhesion material 4 to the outside.

Next, the laminated thin film of the copper foil 3, to which the low-adhesion material 4 adheres, is detached from the carrier 2 (a detachment process).

As described above, the production method uses the non-metallic carrier 2 but does not use a SUS intermediate plate (a metal) and the like. Thus, there is no contamination of the etching solution attributed to elution of a component of the SUS intermediate plate (the metal) and the like.

As a consequence, by applying the above-described processes, it is possible to provide the method for producing the laminated substrate using the metal foil 1 with a carrier, which can improve workability of producing the laminated substrate.

Specific examples of the metal foil with a carrier according to the present invention will be described with reference to FIG. 8 and FIG. 9.

Metal foils with a carrier according to Example 1 and Example 2 have substantially the same structures, etc. as the metal foil with a carrier according to the embodiment of the present invention, and descriptions concerning the same structures will be omitted. In addition, the same constituents in the metal foils with a carrier according to Example 1 and Example 2 will be denoted by the same reference numerals in the descriptions.

### Example 1

A metal foil 21 with a carrier according to Example 1 of the present invention will be described with reference to FIG. 8. FIG. 8(a) is a view showing a carrier of the metal foil 21 with a carrier according to Example 1 of the present invention. FIG. 8(b) is a view showing a configuration of the metal foil 21 with a carrier according to Example 1 of the present invention. FIG. 8(c) is a view showing the metal foil 21 with a carrier according to Example 1 of the present invention after being subjected to press molding.

As shown in FIG. 8(a) to FIG. 8(c) , the metal foil 21 with a carrier essentially includes a non-metallic plate-shaped carrier (a base material) 22, a copper foil (a metal foil) 23 laminated on at least one surface of the carrier 22, and the low-adhesion material 4 provided between the copper foil 23 and the carrier 22 and adhering to the copper foil 23.

The copper foil 23 is an electrolytic copper foil having a thickness of 5 μm. A mold release agent (a material obtained by mixing 50% of a silicon resin with PVA) with a thickness of 1 μm is applied to one surface (an S surface or a shiny surface) of the copper foil 3. Then, the copper foil 23 to which the mold release agent is applied is cut into the size of 500 mm ×500 mm (an outline machining process). A prepreg sheet 25 having a thickness of 20 μm is employed as the bonding agent 5 (see FIG. 6).

### Example 2

A metal foil 31 with a carrier according to Example 2 of the present invention will be described with reference to FIG. 9. FIG. 9(a) is a view showing a carrier of the metal foil 31 with a carrier according to Example 2 of the present invention. FIG. 9(b) is a view showing a configuration of the metal foil 31 with a carrier according to Example 2 of the present invention. FIG. 9(c) is a view showing the metal foil 31 with a carrier according to Example 2 of the present invention after being subjected to press molding.

As shown in FIG. 9(a) to FIG. 9(c), the metal foil 31 with a carrier essentially includes a non-metallic plate-shaped carrier (a base material) 32, a copper foil (a metal foil) 33 laminated on at least one surface of the carrier 32, and the low-adhesion material 4 provided between the copper foil 33 and the carrier 32 and adhering to the copper foil 33.

Like in Example 1, the copper foil 33 is an electrolytic copper foil having a thickness of 5 μm. A mold release agent (a material obtained by mixing 50% of a silicon resin with PVA) with a thickness of 1 μm is applied to one surface (an S surface or a shiny surface) of the copper foil 3.

Then, the copper foil 23, to which the mold release agent is applied, is cut into the size of 500 mm×500 mm (an outline machining process). A 0.5-mmt prepreg sheet 32 (17×10⁻⁶/k) is used as a carrier 32 and is cut into the size of 550 mm×550 mm.

By using the prepreg plate 32 (17×10⁻⁶/k) as described above, the prepreg plate 32 functions as the base material (the carrier) as well as the bonding agent. Thus, a bonding agent or a bonding agent sheet is no longer necessary.

Hence, the number of components of the metal foil 31 with a carrier is reduced. Thus, it is possible to reduce production cost in the method for producing the laminated substrate using the metal foil 31 with a carrier.

As described above, the metal foil 1, 21, 31 with a carrier according to the embodiment of the present invention is the metal foil 1, 21, 31 with a carrier including: the non-metallic plate-shaped carrier 2, 22, 32; the copper foil 3, 23, 33 laminated on at least one surface of the carrier 2, 22, 32; and the low-adhesion material 4 provided between the copper foil 3, 23, 33 and the carrier 2, 22, 23 and adhering to the copper foil 3, 23, 33. Here, the low-adhesion material 4 is made of the mixture of polyvinyl alcohol and silicone.

In addition, in the metal foil 1, 21, 31 with a carrier according to the embodiment of the present invention, the cutout region (the portion A from the end surface of the copper foil 3, 23, 33 to the end surface of the carrier (the base material) 2, 22, 32) where the copper foil 3, 23, 33 is surrounded by the carrier 2, 22, 32 is provided around the copper foil 3, 23, 33.

Meanwhile, the method for producing a laminated substrate using the metal foil 1, 21 with a carrier according to the embodiment of the present invention is a method for producing a laminated substrate using the metal foil 1 with a carrier including: the non-metallic plate-shaped carrier 2, 22, 32; the copper foil 3, 23, 33 laminated on at least one surface of the carrier 2, 22, 32; and the low-adhesion material 4 provided between the copper foil 3, 23, 33 and the carrier 2, 22, 23 and adhering to the copper foil 3, 23, 33. Here, the method includes: the lamination process to laminate the copper foil 3, 23, 33, to which the low-adhesion material 4 adheres, on the carrier 2; the cutting process to cut the cutout region (the portion A from the end surface of the copper foil 3, 23, 33 to the end surface of the carrier (the base material) 2, 22, 32) provided around the copper foil 3, 23, 33 in such a manner that the copper foil 3, 23, 33 is surrounded by the carrier 2, 22, 23; and the detachment process to detach the thin film laminated in the lamination process from the carrier 2, 22, 32.

According to the metal foil 1, 21, 31 with a carrier of the embodiment of the present invention, the low-adhesion material 4 is made of the mixture of polyvinyl alcohol and silicone. Thus, the extra low-adhesion material 4 can be easily removed by water rinsing or acid rinsing during the work for producing the laminated substrate.

Since the low-adhesion material 4 can be easily removed by water rinsing or acid rinsing, the low-adhesion material 4 can be evenly removed. Thus, it is possible to provide the metal foil 1, 21, 31 with a carrier which can improve workability of producing the laminated substrate.

Since the expansion coefficient of the carrier (the base material) 2, 21, 32 is optimized, it is possible to avoid occurrence of warpage, a change in scaling, and the like and thereby to improve a product yield.

According to the metal foil 1, 21, 31 with a carrier of the embodiment of the present invention, the cutout region (the portion A from the end surface of the copper foil 3, 23, 33 to the end surface of the carrier (the base material) 2, 22, 32) where the copper foil 3, 23, 33 is surrounded by the carrier 2, 22, 32 is provided around the copper foil 3, 23, 33. Thus, the low-adhesion material 4 can be prevented from being exposed from the end surface of the copper foil 3, 23, 33 to the outside, and from detachment caused by a machining load associated with the exposure of the low-adhesion material 4 to the outside.

According to the method for producing a laminated substrate using the metal foil 1, 21, 31 with a carrier according to the embodiment of the present invention, the bonding agent 5 bonds the end surfaces of the copper foil 3, 23, 33 (the one end 3a of the copper foil and the other end 3b of the copper foil). Thus, the bonding agent 5 can prevent the chemical solution in the etching or plating process from infiltrating between the copper foil 3, 23, 33 and the carrier (the base material) 2, 22, 32. As a consequence, it is possible to prevent detachment of the copper foil 3, 23, 33 from the base material 2, 22, 32.

Since the low-adhesion material 4 is not exposed from the end surfaces of the copper foil 3, 23, 33 (the one end 3a of the copper foil and the other end 3b of the copper foil) to the outside, the interface between the carrier 2, 22, 32 and the copper foil 3, 23, 33 adopting the low-adhesion structure is not detached.

During immersion in the chemical solution in the etching or plating process, the chemical solution does not infiltrate from the interface at the low-adhesion portion between the carrier 2, 22, 32 and the copper foil 3, 23, 33 or does not adversely affect the subsequent process. Thus, it is possible to avoid the machining load associated with exposure of the low-adhesion material 4 to the outside.

The production method does not use a SUS intermediate plate (the metal) and the like. Thus, there is no contamination of the etching solution which is attributed to elution of the component of the SUS intermediate plate (the metal) and the like.

As a consequence, by applying the above-described processes, it is possible to provide the method for producing the laminated substrate using the metal foil 1, 11, 21 with a carrier, which can improve workability of producing the laminated substrate.

The metal foil 31 with a carrier according to Example 2 of the present invention uses the prepreg 32 (17×10⁻⁶/k), which functions as the base material (the carrier) as well as the bonding agent. Thus, a bonding agent or a bonding agent sheet is no longer necessary.

Hence, the number of components of the metal foil 31 with a carrier is reduced. Thus, it is possible to reduce production cost in the method for producing the laminated substrate using the metal foil 31 with a carrier.

Although the metal foil with the carrier and the method for producing the laminated substrate using the metal foil with the carrier of the present invention have been described above on the basis of the illustrated embodiment and examples, the present invention is not limited thereto and the structures of the constituents can be replaced with any structures having similar functions.

1. (canceled)

2. (canceled)

3. (canceled)

4. (canceled)

5. (canceled)

6. (canceled)

7. (canceled)

8. (canceled)

9. A metal foil with a carrier comprising:
a non-metallic plate-shaped carrier;
a metal foil laminated on at least one surface of the carrier; and
a low-adhesion material provided between the metal foil and the carrier to adhere to the metal foil,
wherein a cutout region where the metal foil is surrounded by the carrier is provided around the metal foil.
